(19) United States
(12) Patent Application Publication
(10) Pub. No.: US 2026/0017631 A1
(43) Pub. Date: Jan. 15, 2026

(54) SYSTEMS AND METHODS FOR PROCESSING DIRECT ELECTRICAL ENERGY TRANSFER PAYMENTS AT POINT OF INTERACTION

(71) Applicant: Mastercard International Incorporated, Purchase, NY (US)

(72) Inventors: Shawn Mehrhoff, Saint Ann, MO (US); Christopher T. Scholl, Manchester, MO (US); Kaushal Shetty, O'Fallon, MO (US)

(73) Assignee: Mastercard International Incorporated, Purchase, NY (US)

(21) Appl. No.: 18/768,351

(22) Filed: Jul. 10, 2024

(51) Int. Cl. G06Q 20/20; G06Q 20/40; G06Q 50/06

(52) U.S. Cl. CPC G06Q 20/204; G06Q 20/401; G06Q 50/06

(57) ABSTRACT

A system/method includes a processor configured to receive a transaction request from a cardholder device and determine that the transaction request corresponds to a direct electrical energy transfer transaction. The processor transmits a transaction cost to the cardholder device, including a cash currency value and an electrical energy amount equivalent to the cash currency value. The processor receives payment data from the cardholder device, transmits an authorization request to a payment network for approval, and receives a payment authorization request response from the payment network approving the transaction. The processor receives an amount of electrical energy from the cardholder device. The processor then determines the amount of electrical energy received from the cardholder device and conducts the transaction using payment with electrical energy based on the amount of electrical energy received.

### BACKGROUND

This disclosure relates generally to electronic payment systems, and more specifically to electronic payment systems for processing direct electrical energy transfer payments at a point-of-sale terminal.

Payment processing systems are in widespread use to process transactions between a cardholder and a merchant, via an acquirer bank and an issuing bank. The transactions may involve a cardholder's mobile payment device at a point-of-sale (POS) terminal. Such payment card processing systems typically process payment transactions, confirm authorized charges, manage payments and transfer of funds, confirm payment status, and compute available credit balances.

Conventional payment systems are generally not well-suited for payment transactions involving forms or payment other than money. Such non-monetary payments, however, may be desirable to merchants and cardholders. In particular, a direct electrical energy exchange between merchants and cardholders would be desirable but is not currently available using conventional payment systems. Payment systems capable of performing direct electrical energy exchanges for payment transactions presently do not exist.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system is provided. The system includes a wireless power/communication interface, an energy storage device, one or more processors, and a memory device storing computer-executable instructions thereon that, when executed by the one or more processors, cause the one or more processors to receive a transaction request from a cardholder device associated with a cardholder. The processor determines that the transaction request corresponds to a direct electrical energy transfer transaction. The direct electrical energy transfer transaction involves a purchase of goods or services by the cardholder in exchange for an amount of electrical energy transferrable to a merchant via the cardholder device. The processor transmits a transaction cost of the purchase of goods or services to the cardholder device. The transaction cost includes a cash currency value and an electrical energy amount equivalent to the cash currency value. The processor also receives payment data from the cardholder device and transmits a payment authorization request message for the direct electrical energy transfer transaction to a payment network for approval. The payment authorization request message includes the payment data. Furthermore, the processor receives a payment authorization request response message from the payment network. The payment authorization request message includes an approval of the direct electrical energy transfer transaction. After receiving approval of the direct electrical energy transfer transaction, the processor receives, via the wireless power/communication interface, an amount of electrical energy from the cardholder device. The processor determines the amount of electrical energy received from the cardholder device and stores the amount of electrical energy in the energy storage device. The processor conducts the transaction using payment with electrical energy based on the amount of electrical energy received.

In another aspect, a method implemented in a payment processing system is provided. The payment processing system includes a point-of-sale (POS) terminal having one or more processors in communication with a wireless power/communication interface, an energy storage device, a memory device, and a payment network. The method includes receiving a transaction request from a cardholder device associated with a cardholder. The method also includes determining that the transaction request corresponds to a direct electrical energy transfer transaction. The direct electrical energy transfer transaction involves a purchase of goods or services by the cardholder in exchange for an amount of electrical energy transferrable to a merchant via the cardholder device. In addition, the method includes transmitting a transaction cost of the purchase of goods or services to the cardholder device. The transaction cost includes a cash currency value and an electrical energy amount equivalent to the cash currency value. The method also includes receiving payment data from the cardholder device and transmitting a payment authorization request message for the direct electrical energy transfer transaction to the payment network for approval. The payment authorization request message includes the payment data. Furthermore, the method includes receiving a payment authorization request response message from the payment network. The payment authorization request message includes an approval of the direct electrical energy transfer transaction. Moreover, the method includes, after receiving approval of the direct electrical energy transfer transaction, receiving, via the wireless power/communication interface, an amount of electrical energy from the cardholder device. The method also includes determining the amount of electrical energy received from the cardholder device and storing the amount of electrical energy in the energy storage device. Additionally, the method includes conducting the transaction using payment with electrical energy based on the amount of electrical energy received.

In another aspect, a non-transitory computer readable medium (CRM) is provided. The CRM includes computer-executable instructions that when executed by a computing device having one or more processors in communication with a wireless power/communication interface, an energy storage device, a memory device, and a payment network cause the computing device to receive a transaction request from a cardholder device associated with a cardholder. The computer-executable instructions cause the computing device to determine that the transaction request corresponds to a direct electrical energy transfer transaction. The direct electrical energy transfer transaction involves a purchase of goods or services by the cardholder in exchange for an amount of electrical energy transferrable to a merchant via the cardholder device. Furthermore, the computer-executable instructions cause the computing device to transmit a transaction cost of the purchase of goods or services to the cardholder device. The transaction cost includes a cash currency value and an electrical energy amount equivalent to the cash currency value. The computer-executable instructions also cause the computing device to receive payment data from the cardholder device and transmit a payment authorization request message for the direct electrical energy transfer transaction to the payment network for approval. The payment authorization request message includes the payment data. Moreover, the computer-executable instructions cause the computing device to receive a payment authorization request response message from the payment network. The payment authorization request message includes an approval of the direct electrical energy transfer transaction. After receiving approval of the direct electrical energy transfer transaction, the computer-executable instructions cause the computing device to receive, via the wireless power/communication interface, an amount of electrical energy from the cardholder device. The computer-executable instructions then cause the computing device to determine the amount of electrical energy received from the cardholder device and store the amount of electrical energy in the energy storage device. Additionally, the computer-executable instructions cause the computing device to conduct the transaction using payment with electrical energy based on the amount of electrical energy received.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic diagram illustrating an exemplary multi-party payment network system for processing payment card transactions;

FIG. 2 is a schematic diagram illustrating an exemplary cardholder computing device for the system shown in FIG. 1;

FIG. 3 is a schematic diagram illustrating an exemplary computing system for the system shown in FIG. 1;

FIG. 4 is a schematic diagram illustrating an exemplary electrical energy device for the system shown in FIG. 1;

FIG. 5 is a flowchart illustrating an exemplary computer-implemented method for registering a cardholder or a merchant for an electrical energy transfer payment service, in accordance with an embodiment of the present disclosure; and

FIG. 6 is a flowchart illustrating an exemplary computer-implemented method for performing an electrical energy transfer transaction between a cardholder and a merchant, in accordance with an embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

Broadly, the systems and methods of the disclosure allow payment transactions between a merchant and a customer that involve an exchange of electrical energy, herein referred to as direct electrical energy transfer transactions. Such transactions may be desirable for a consumer who has a portable power bank and/or consumer computing device with a power source having excess power and a merchant that has an energy storage device, such as a battery or backup electrical power system. When initiating a transaction, the consumer may select to perform a direct electrical energy transfer transaction. The merchant may retrieve a current monetary rate of electrical energy. The rate may be used to determine an amount of electrical energy required to cover the amount due for the goods or services being received, which form the basis of the transaction. The consumer may then provide electrical energy to the merchant to cover the amount due or a lesser amount. If the amount of electrical energy provided is less than the transaction cost, the amount due may be charged by the merchant to a payment account of the consumer.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle Database (Oracle is a registered trademark of Oracle Corporation, Redwood Shores, Calif.), MySQL, IBM DB2 (IBM is a registered trademark of International Business Machines Corporation, Armonk, N.Y.), Microsoft SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). SQL, as used herein, stands for structured query language, which is a programming language for storing and processing information in a relational database. It is noted that any database may be used that enables the systems and methods to operate as described herein.

### Example System

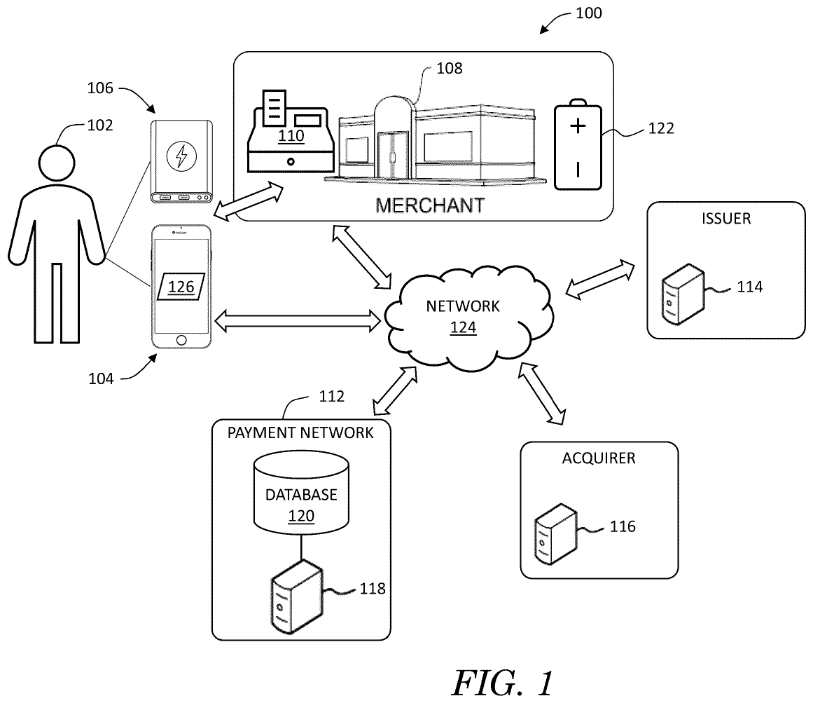

FIG. 1 is a schematic diagram illustrating an exemplary multi-party payment processing system 100 for processing payment transactions, in accordance with an aspect of the present invention. In the example payment processing system 100, a cardholder 102 may have access to a consumer computing device 104 through which the cardholder 102 may perform a payment transaction to a merchant 108. As described herein, the cardholder 102 may also have access to an electrical energy device 106 through which the cardholder 102 may transfer electrical energy to the merchant 108, and more particularly to a merchant energy storage device 122 (also referred to herein as a battery), as part of the payment transaction.

Embodiments described herein may relate to a payment card system, such as a payment system using the Mastercard® interchange network. (Mastercard is a registered trademark of Mastercard International Incorporated.). The Mastercard interchange network is a set of proprietary communications standards promulgated by Mastercard for the exchange of financial transaction data and the settlement of funds between financial institutions that are members of the Mastercard interchange network. Embodiments described herein may also relate to digital payment services such as Masterpass® by Mastercard or another digital wallet service for a mobile device such as a smartphone.

In payment processing system 100, a financial institution, such as an issuing bank or issuer 114 (and its associated computers), issues a payment account, such as a credit card account or a debit card account, to the cardholder 102, who uses the payment account (or payment card associated with the payment account) to tender payment for a purchase from the merchant 108. To accept payment from the cardholder 102, the merchant 108 must normally establish an account with a financial institution that is part of the system 100. This financial institution is usually called a “merchant bank,” an “acquiring bank,” or simply an “acquirer,” represented by reference character 116.

When the cardholder 102 tenders payment for a purchase (e.g., with a payment card, virtual card, digital wallet, etc.), the merchant 108 requests authorization from the acquirer 116 (and its associated computers) for the amount of the purchase. The request may be performed over the telephone or via a website but is oftentimes performed through the use of a point-of-sale (POS) terminal of the merchant 108, such as the POS terminal 110. The POS terminal 110 reads the cardholder's account information from the payment card or digital wallet and communicates electronically with the transaction processing computers of the acquirer 116. Alternatively, the acquirer 116 may authorize a third party to perform transaction processing on its behalf. In such a case, the POS terminal 110 may be configured to communicate with the third party. Such a third party is usually called a “merchant processor” or an “acquiring processor.”

Using a payment network 112 (or payment processor), computers of the acquirer 116 or the merchant processor will communicate with computers of the issuing bank or issuer 114 to determine whether the cardholder's account is in good standing and whether the purchase amount is covered by the cardholder's available credit line or account balance. Based on these determinations, the request for authorization will be declined or accepted. If the request is accepted, the transaction is given a bank network reference number, such as the Banknet Reference Number, an authorization code, and/or other transaction identifiers that may be used to identify the transaction.

The POS terminal 110, the acquirer computers 116, the payment network 112, and the issuer computers 114 may be coupled in communication via a communications network 124. The network 124 may include, for example and without limitation, one or more of a local area network (LAN), a wide area network (WAN) (e.g., the Internet, etc.), a mobile network, a virtual network, and/or any other suitable public and/or private network capable of facilitating communication among the POS terminal 110, the acquirer computers 116, the payment network 112, and/or the issuer computers 114. In some embodiments, the network 124 may include more than one type of network, such as a private payment transaction network provided by the payment network 112 to the acquirer computers 116 and the issuer computers 114, and, separately, the public Internet, which may facilitate communication between the POS terminal 110 (or merchant 108), the payment network 112, the acquirer computers 116, the issuer computers 114, and the cardholder 102, etc.

The payment processing system 100 may be configured to process authorization messages, such as ISO® 8583 compliant messages and ISO® 20022 compliant messages. (ISO is a registered trademark of the International Organization for Standardization of Geneva, Switzerland.) As used herein, ISO refers to a series of standards approved by the International Organization for Standardization. ISO 8583 compliant messages are defined by the ISO 8583 standard, which governs financial transaction card-originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. ISO 20022 compliant messages may include acquirer to issuer card messages (ATICA).

During an authorization process of the payment processing system 100, a clearing process is also taking place. During the clearing process, the acquirer 116 provides issuing bank 114 with information relating to the purchase. No money is exchanged during clearing. Clearing (also referred to as “first presentment”) involves the exchange of data required to identify the cardholder's account, such as the account number, expiration date, billing address, amount of the sale, and/or other transaction identifiers that may be used to identify the transaction. Along with this data, banks in the United States also include a bank network reference number, such as the Banknet Reference Number, which identifies that specific transaction. When the issuing bank 114 receives this data, it posts the amount of sale as a draw against the available credit in the cardholder account and prepares to send payment to the acquirer 116.

After a request for authorization is accepted, the available credit line or available account balance of cardholder's account is decreased. Normally, a charge is not posted immediately to a cardholder's account because bankcard associations, such as Mastercard, have promulgated rules that do not allow a merchant to charge, or “capture,” a transaction until the purchased goods are shipped or services are delivered. When the merchant 108 ships or delivers the goods or services, the merchant 108 captures the transaction by, for example, appropriate data entry procedures on the POS terminal 110. If the cardholder 102 cancels a transaction before it is captured, a “void” is generated. If the cardholder 102 returns goods after the transaction has been captured, a “credit” is generated. The payment network 112 may store the transaction information, such as, and without limitation, a type of merchant, a merchant identifier, a location where the transaction was completed, an amount of purchase, and a date and time of the transaction, in a transaction database, such as the transaction database 120.

After a transaction is authorized and cleared, the transaction is settled between the merchant 108, the acquirer 116, and the issuing bank 114. Settlement refers to the transfer of financial data or funds between the merchant's account, the acquirer 116, and issuing bank 114 related to the transaction. Usually, transactions are captured and accumulated into a “batch,” which is settled as a group.

Normally, an interchange fee may be paid by the acquirer to the issuer with respect to a particular transaction. These fees are typically expressed as a percentage of the transaction value, plus a flat fee per transaction. The purpose of the interchange fee is to compensate the issuer for a portion of the risks and costs it incurs. For example, the interchange fee helps to cover the costs associated with processing the transaction, such as fraud prevention and data processing.

The transactions described above are referred to herein as monetary transactions and are distinguished from non-monetary transactions including alternative forms of payments, such as in the direct electrical energy transfer payments or transactions described herein.

### Exemplary Computer Systems

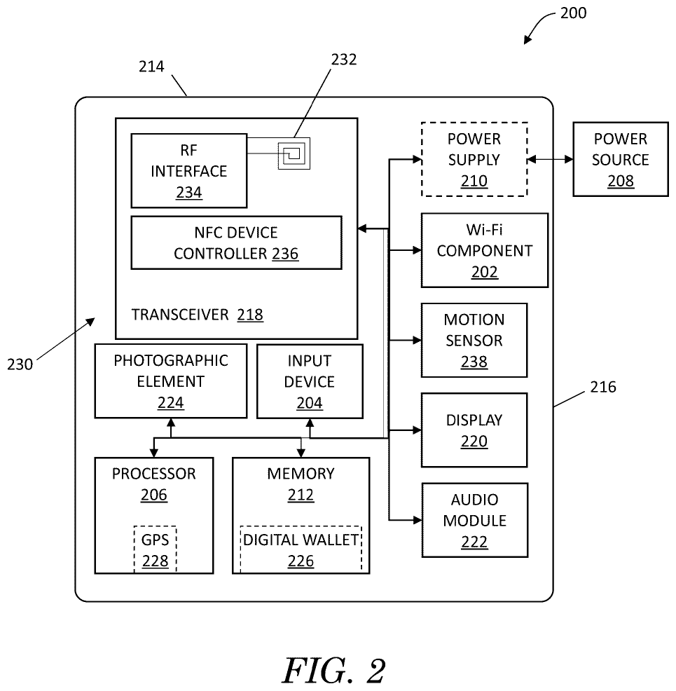

FIG. 2 is an example configuration of a user computing system 200, such as the consumer computing device 104 (shown in FIG. 1) that may be operated by a user, such as the cardholder 102 (shown in FIG. 1). In the exemplary embodiment, the computing system 200 may be a computing device configured to connect wirelessly to one or more of the merchant 108, the POS terminal 110, the network 124, and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 may include one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 may be any device allowing information such as payment card data, the executable instructions, and/or other data to be stored and retrieved. The memory device 212 may include one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 may provide a mechanism for automatically updating the software on the computing system 200. For example, an updating mechanism may be used to automatically update any number of components and their drivers, both network and non-network components, including system level (OS) software components. In some embodiments, the components of the computing system 200 may be dynamically loadable and unloadable; thus, they may be replaced in operation without having to reboot the OS.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, a GPS chip 228 may be part of or separate from the processor 206 to enable the location (or geolocation) of the computing system 200 to be determined.

The Wi-Fi component 202 (broadly, a communication interface) may be communicatively connectable to a remote device such as the merchant computer or POS terminal 110 and the network 124. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near-field communication (NFC), and/or with a mobile phone network, Global System for Mobile communications (GSM), 5G, or other mobile data network, and/or Worldwide Interoperability for Microwave Access (WiMax) and the like.

Stored in the memory device 212 may be, for example, computer readable instructions for providing a user interface to the user, such as the cardholder 102, via the display 220 and, optionally, receiving and processing input from the input device 204. A user interface may include, among other possibilities, a web browser, a client application, a digital wallet application 226, and the like. Web browsers may enable users, such as the cardholder 102, to view and interact with media and other information typically embedded on a web page or a website. A digital wallet may allow the cardholder 102 to receive, generate, and/or store payment credentials, such as tokens associated with a payment card and/or a virtual payment credential. The digital wallet application 226 (broadly, a digital wallet), is linked to a digital wallet service and/or installed on the user computing system 200. It is contemplated that more than one digital wallet may be associated with the user computing system 200 and accessible by the user interface, where each digital wallet is associated with at least one financial institution (such as the issuer 114).

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, the motion sensor 238 may detect when the cardholder 102 moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the cardholder 102, for example, by detecting that the cardholder 102 has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 124 (shown in FIG. 1) and/or other computing devices (e.g., other mobile devices, the computers, devices, or systems 106, 110, 112, 114, 116, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the computing system 200. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 may be fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 may be fabricated from any material that enables the computing system 200 to function as described herein, such as metals, etc.

In one embodiment, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers, devices, or systems 106, 110, 112, 114, and 116, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the merchant computer or POS terminal 110. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the power source 208, and in some embodiments, the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

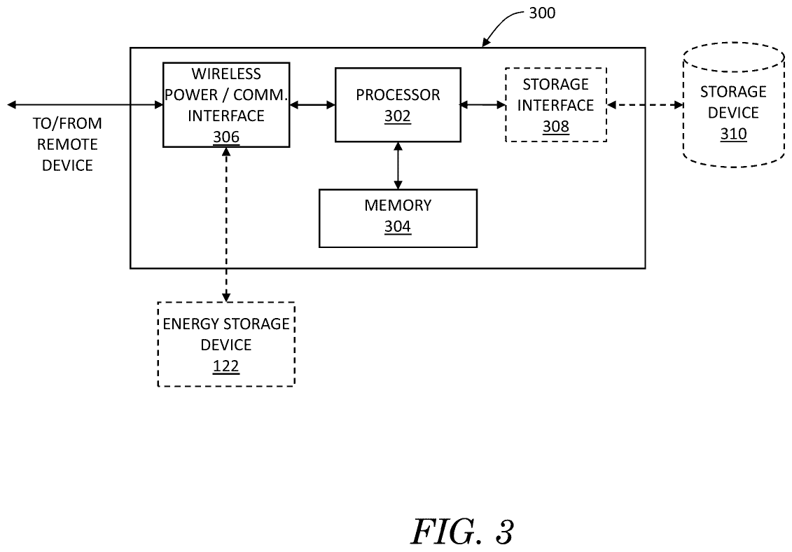

FIG. 3 is an example configuration of a computing system 300. In an embodiment, the computing system 300 may include, but not be limited to, the merchant computer or POS terminal 110, the acquirer computer 116, a payment processor computer 118, and/or the issuer computer 114 (all shown in FIG. 1). In the example embodiment, the computing system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the computing system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 may be operatively coupled to a wireless power/communication interface 306 such that the computing system 300 can communicate with a remote device such as a user computing system 200 (shown in FIG. 2), one or more of the computers, devices, or systems 104, 106, 110, 112, 114, and 116, and/or another server system. For example, the wireless power/communication interface 306 may receive communications from a consumer computing device 104 via the Internet (FIG. 1). In certain embodiments, the wireless power/communication interface 306 may be configured to wirelessly transfer electrical power (or energy) between a suitable electrical energy device, such as the consumer computing device 104 or electrical energy device 106 (each shown in FIG. 1) via an inductive link. As will be appreciated by persons skilled in the relevant art, such wireless power transfer may be carried out over an inductive link in accordance with the well-known principles of inductive coupling or resonant inductive coupling. The wireless power/communication interface 306 may also be connected to one or more energy storages devices, such as the external energy storage device 122, for transferring electrical energy therebetween.

The processor 302 may be operatively coupled to the storage device 310. The storage device 310 may be any computer-operated hardware suitable for storing and/or retrieving data. In some embodiments, the storage device 310 may be integrated in the computing system 300. In other embodiments, the storage device 310 may be external to the computing system 300. The storage device may be similar to the database 120 (shown in FIG. 1). For example, the computing system 300 may include one or more hard disk drives as the storage device 310. In other embodiments, the storage device 310 may be external to the computing system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

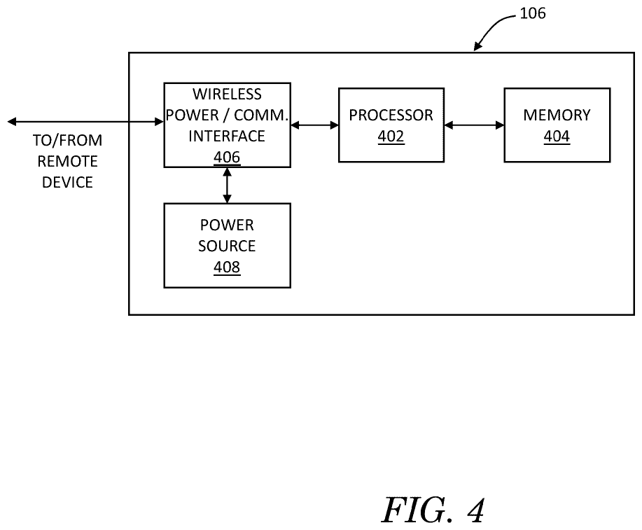

FIG. 4 is an example configuration of the electrical energy device 106. In the example embodiment, the electrical energy device 106 may be configured to transfer electrical energy or power to/from a remote device, for example, via induction. For example, in an embodiment, the electrical energy device 106 may be configured to transfer electrical energy to the POS terminal 110 (shown in FIG. 1) as payment (or partial payment) for a transaction performed by the cardholder 102. The electrical energy device 106 may be configured to transfer electrical energy wirelessly (via induction) and/or via direct connection via a cable or wire.

In the example embodiment, the electrical energy device 106 may include a processor 402 for executing instructions. The instructions may be stored in a memory 404, for example. In an embodiment, one or more processes executed by the electrical energy device 106 may be implemented in the form of programming instructions of one or more software modules or components, such as a wireless power/communication interface 406. However, it will be apparent that the processes could alternatively be implemented, either in part or in their entirety, in the form of one or more dedicated hardware components, such as application-specific integrated circuits (ASICs), and/or in the form of configuration data for configurable hardware components, such as field programmable gate arrays (FPGAs), for example.

In the example, the processor 402 may include one or more processing units (e.g., in a multi-core configuration) for executing the instructions. The instructions may be executed within a variety of different operating systems on the electrical energy device 106, such as UNIX, LINUX, Microsoft Windows®, etc. It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 may be operatively coupled to the wireless power/communication interface 406 such that the electrical energy device 106 can communicate with and/or transfer electrical energy to/from a remote device such as a user computing system 200 (shown in FIG. 2), one or more of the computers or systems 104, 110, 112, 114, 116, and 118, and/or another electrical energy device. For example, the wireless power/communication interface 406 may receive communications from a consumer computing device 104 and/or one or more merchant computers or POS terminals 110 via wireless communication (e.g., using the NFC protocol) or via the network 124.

The electrical energy device 106 may include a power source 408 connected to a wireless power/communication interface 406. The wireless power/communication interface 406 may be configured to wirelessly transfer electrical power supplied by a power source 408 to a wireless power/communication interface associated with the POS terminal 110 (e.g., the interface 306 shown in FIG. 3) via an inductive link. As will be appreciated by persons skilled in the relevant art, such wireless power transfer may be carried out over an inductive link in accordance with the well-known principles of inductive coupling or resonant inductive coupling.

The memory 404 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Exemplary Computer-Implemented Methods

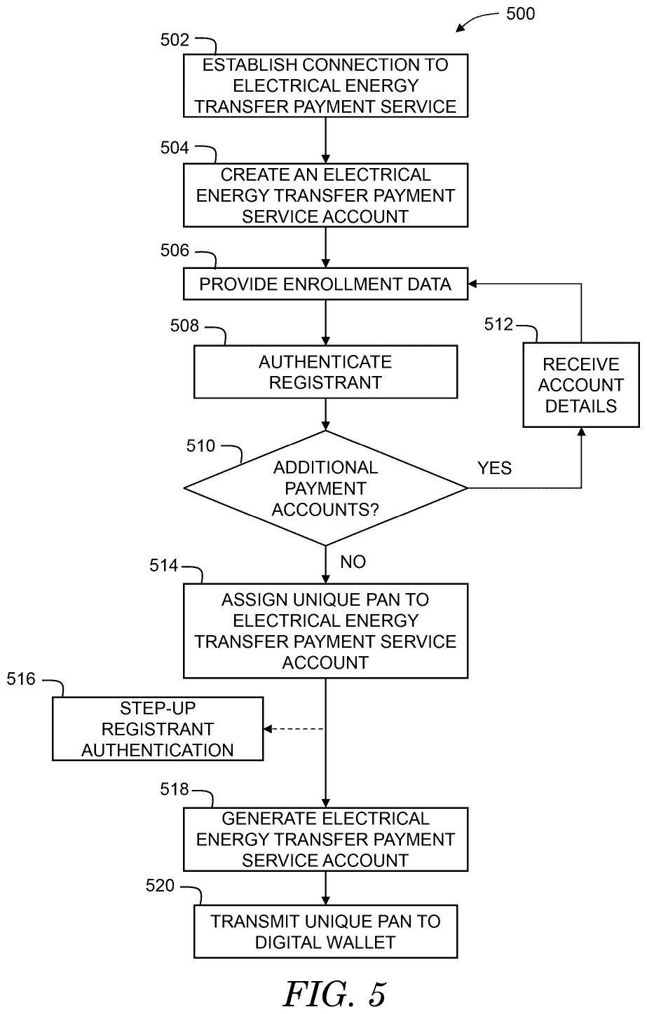

FIG. 5 is a flowchart illustrating an exemplary computer-implemented method 500 for registering the cardholder 102 or a merchant 108 (also referred to as the “registrant”) (shown in FIG. 1) for an electrical energy transfer payment service provided by the payment network 112 (shown in FIG. 1), via the payment processor computer 118 for example (shown in FIG. 1), in accordance with one embodiment of the present disclosure. The operations described herein may be performed in the order shown in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 500 is described below, for ease of reference, as being executed by exemplary devices and components introduced with the embodiments illustrated in FIGS. 1-4. In one embodiment, the computer-implemented method 500 is implemented by the payment processor computer 118. In the exemplary embodiment, the computer-implemented method 500 relates to receiving registration information from the cardholder 102 upon registration for the electrical energy transfer payment service. While operations within the computer-implemented method 500 are described below regarding the payment processor computer 118, according to some aspects of the present invention, the computer-implemented method 500 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The registrant (e.g., the cardholder 102 or merchant 108) must be registered for the electrical energy transfer payment service to perform an electrical energy transfer transaction. Referring to operation 502, in the example embodiment, the registrant connects to the payment processor computer 118 via the payment network 112, e.g., via a webservice providing electrical energy transfer payment service registration via use of a web browser. Alternatively, the registrant may access the payment processor computer 118 via an account registration application 126 (shown in FIG. 1), which is configured for direct connection to the payment processor computer 118. In such instances, the application 126 may be stored in a cloud-based interface, which may include cloud storage capability as well as any cloud-based application programming interface (API) that facilitates communication between a registrant computing device and the payment processor computer 118. In an embodiment, the account registration application 126, when executed by the payment processor computer 118 and/or the consumer computing device 104, enables the payment processor computer 118 to handle requests from cardholders, such as the cardholder 102, to register for electrical energy transfer payment services provided by the payment processor computer 118. Using the account registration application 126, the cardholder 102 creates an account. The account operates to allow the cardholder 102 to provide account data and/or receive account services maintained by the payment processor computer 118.

At operation 504, the registrant is presented an option to create an electrical energy transfer payment service account. For example, the registrant registers or enrolls for the electrical energy transfer payment service via a suitable webpage of the payment processor computer 118 using, for example, a registrant computing device such as the consumer computing device 104. It should be understood that the registrant may enroll or register with the electrical energy transfer payment service in any of several ways, including utilizing a suitable computing device to access the payment processor computer 118 via the Internet and providing the requisite information.

At operation 506, the registrant provides enrollment data including basic information about himself or herself (e.g., name, address, phone number, etc.) and, in some embodiments, information regarding the registrant's computing device, i.e., a device identifier (ID). The device ID may include, for example, a hardware identifier, a SIM (Subscriber Identity Module) identifier, a mobile telephone number, and/or other computing device identifier. The enrollment data may also include payment data to be associated with the electrical energy transfer payment service account. For example, the registrant may provide one or more payment cards (e.g., a bank credit card primary account number, debit card primary account number, loyalty card primary account number, gift card primary account number, and the like) issued to or held by him or her. The registrant may also provide preferences data concerning a priority or ranking associated with the payment accounts/cards if there are more than one provided. As such, when a transaction requires use of a payment account, the payment accounts may be selected based on priority or ranking. It is noted that the electrical energy transfer payment service account can be linked to other Mastercard services if the registrant is already signed up for other unrelated services. In some embodiments, the information obtained from the registrant during the enrollment process includes product and/or service preferences, requirements data, and/or other information.

At operation 508, the payment processor computer 118 authenticates the registrant. For example, and without limitation, the payment processor computer 118 may authenticate the registrant via a one-time code sent to the registrant, for example, via Short Message Service (SMS), e-mail, through a call center communication, and the like. Alternatively, or in addition, the cardholder may be asked to input a string of characters indicating a code printed on a signature panel of the cardholder's payment card. The signature panel code may be, for example, a card verification code (CVC) value. The values entered by the cardholder 102 may be used by the payment processor computer 118 to authenticate the cardholder 102 prior to setting up the electrical energy transfer payment service account and associating the cardholder 102 and the cardholder's payment account with the electrical energy transfer payment service account. For example, the payment processor computer 118 may compare the entered values to the values associated with the payment card stored in a database (e.g., the database 120 shown in FIG. 1). If the entered values match the stored values, the cardholder 102 is authenticated. Optionally, the method 500 may include an additional operation for authenticating the registrant offline. For example, and without limitation, the payment processor computer 118 may provide an offline PIN to the registrant via mail.

At operation 510, the payment processor computer 118 asks whether the registrant has additional payment cards or accounts it wishes to associate with the electrical energy transfer payment service account. If the registrant has additional payment cards or accounts to enter, at operation 512, the payment processor computer 118 receives the additional payment card or account details from the registrant and returns to operation 506. If the registrant does not have any additional payment cards or accounts to enter, the method continues to optional operation 514 or operation 516.

At operation 514, the payment processor computer 118 assigns a unique primary account number (PAN) to the registrant's electrical energy transfer payment service account. The PAN is associated with the registrant's enrollment data (e.g., the registrant's computing device (i.e., device ID) and payment data) and stored in a mapping table on the database, such as the database 120. Accordingly, the unique PAN is unique to the electrical energy transfer payment service account. In this manner, the registrant may add/update/delete his or her payment data and/or computing device data without the need for changing the electrical energy transfer payment service account PAN. It is noted that the PAN may be tokenized, for example, to facilitate preventing fraud.

At optional operation 516, the payment processor computer 118 requests that the registrant set up a step-up authentication method, such as, two-factor authentication. For example, and without limitation, in one embodiment, the registrant is requested to establish account access credentials, e.g., to select a username and password or PIN (personal identification number) to be used for security purposes, and/or for use by the registrant to login and change one or more preferences related to the electrical energy transfer payment service. In addition to the password or PIN, the registrant may be requested to set up a second authentication factor that is to be associated with the other registration information provided.

In one suitable embodiment, the second factor may include, for example, and without limitation, SMS two-factor authentication (where a one-time use short code is sent to the registrant's computing device via SMS), Time-Based One Time Password (TOTP) authentication (where an authenticator application provides a short code as a second factor), push-based two-factor authentication (where a prompt is pushed out to the registrant's computing device), or any other two-factor authentication method that enables the method 500 to operate as described herein.

In another suitable embodiment, the second factor may include a biometric sample. Biometric samples include, without limitation, a fingerprint image, a voice recording, a retinal image, facial recognition, palm print image, iris recognition, and the like. The biometric sample is unique to the registrant (e.g., the cardholder 102) and difficult to duplicate and/or forge by an unauthorized user. The biometric sample may be stored and associated with a biometric identifier, for example, by the payment processor computer 118 (e.g., in the database 120, etc.). Additionally, the biometric identifier may be associated with the stored registration information and facilitates secure authorization of requested data input by the registrant. A biometric input device in communication with the registrant's computing device may be used for the registrant to enter the biometric sample. For example, the registrant's computing device may include an integral fingerprint or palm reader/scanner, retinal or iris reader/scanner, and/or voice reader/recorder.

At operation 518, the payment processor computer 118 generates the electrical energy transfer payment service account for the registrant, associating the received one or more payment cards or accounts, user device, and PAN (and token) with the account along with the registrant's account access credentials, and stores the electrical energy transfer payment service account in a database, e.g., the database 120. At operation 520, the payment processor computer 118 transmits the token to the registrant's computing device, such as the consumer computing device 200, for storage in a digital wallet thereon, such as the digital wallet 226.

In an embodiment, registration of the registrant includes opt-in informed consent of the registrant to data usage by the system consistent with consumer protection laws and privacy regulations. In some embodiments, the enrollment data and/or other collected data may be anonymized and/or aggregated prior to receipt such that no personally identifiable information (PII) is received. In other embodiments, the system may be configured to receive enrollment data and/or other collected data that is not yet anonymized and/or aggregated, and thus may be configured to anonymize and aggregate the data. In such embodiments, any PII received by the system may be received and processed in an encrypted format, or may be received with the consent of the individual with which the PII is associated. In situations in which the systems discussed herein collect personal information or make use of such personal information, the individuals may be provided with an opportunity to control whether such information is collected or to control whether and/or how such information is used. In addition, certain data may be processed in one or more ways before it is stored or used, so that PII is removed.

The services provided by the electrical energy transfer payment service are contemplated as opt-in services such that only specifically enrolled registrants may experience such services. Permission to utilize location services in the consumer computing device 104 may be obtained as part of the enrollment process. Such opt-in consent may be made in any manner desired and accepted by the payment processor computer 118 providing the electrical energy transfer payment service. In some embodiments, the opt-in consent may be made through the account registration application 126 or digital wallet 226 residing on the consumer computing device 104.

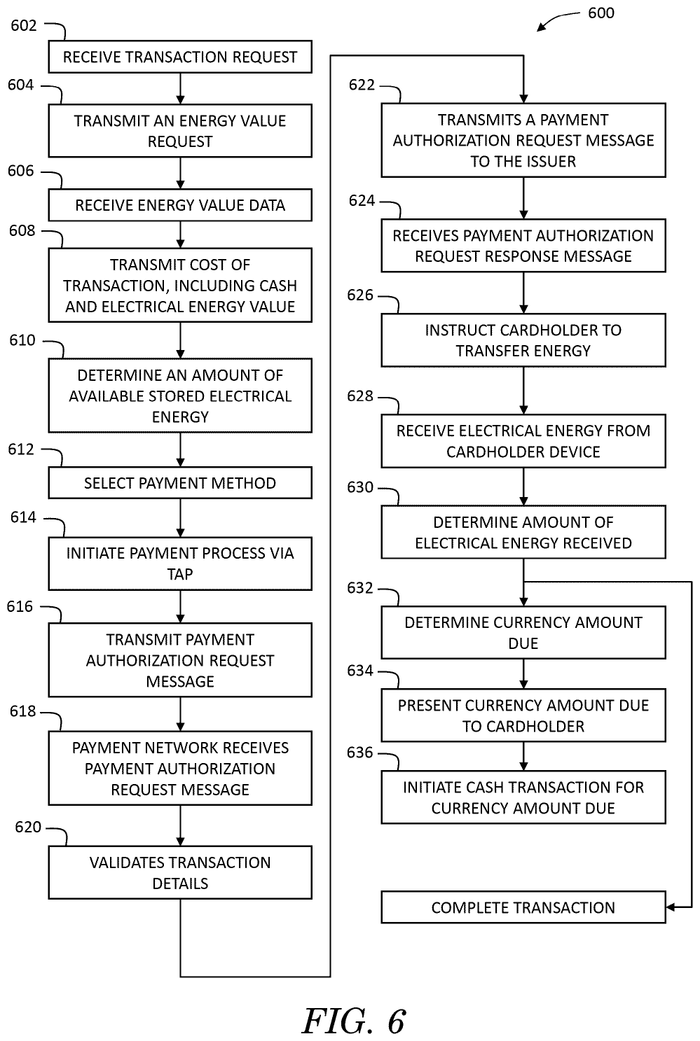

FIG. 6 is a flowchart illustrating an exemplary computer-implemented method 600 for performing an electrical energy transfer transaction between the cardholder 102 (shown in FIG. 1) and the merchant 108 (shown in FIG. 1), in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-4. In one embodiment, the computer-implemented method 600 is implemented by the POS terminal 110. While operations within the computer-implemented method 600 are described below regarding the POS terminal 110, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The method 600 (i.e., the direct electrical energy transfer transaction) provides a way for the cardholder 102 to beneficially utilize their stored electrical energy in a flexible manner for greater convenience and/or greater value in an electrical energy transfer transaction with a third party merchant, such as the merchant 108. In particular, the direct electrical energy transfer transaction involves a purchase of goods or services by the cardholder 102 in exchange for an amount of electrical energy transferrable to the merchant 108 via an electrical energy device of the cardholder 102. To facilitate such a transaction, as described herein, the cardholder 102 has an electrical energy device 106 (or computing device 104) that stores electrical energy thereon. Beneficially, the cardholder 102 may complete a conventional monetary-based transaction with the electrical energy device 106, the consumer computing device 104 (via a digital wallet), and/or a combination of the two. For example, in an embodiment, the direct electrical energy transfer transaction may be entirely monetary, entirely electrical energy-based, or a hybrid transaction including part monetary payment and part electrical energy transfer.

In the exemplary embodiment, the cardholder 102 selects to perform a direct electrical energy transfer transaction with the merchant 108. For example, at operation 602, the merchant POS terminal 110 receives a transaction request from the cardholder 102. The POS terminal 110 determines that the transaction request is a request for a direct electrical energy transfer transaction, for example, based on the transaction request including an input (or a selection) to perform a direct electrical energy transfer transaction for one or more goods and/or services being purchased by the cardholder.

At operation 604, the merchant POS terminal 110 transmits an energy value request message to the payment network 112 (e.g., to the payment processor computer 118). At operation 606, the payment network 112 (e.g., the payment processor computer 118) transmits energy value data to the merchant POS terminal 110. The energy value data may include currency conversion data that allows a quantity of electrical energy to be converted to a cash currency value. The currency conversion data may include data from an electrical energy provider, from external sources, and/or data from third party providers. The conversion data may be real-time calculated values, averaged values over a period of time, or determined in another manner that merchants and cardholders may agree to as part of the enrollment process described above. It is noted that the value of electrical energy fluctuates over time and as such, at any given time, the value of stored electrical energy may be different than the value at other times.

At operation 608, the merchant POS terminal 110 transmits a cost of the purchased goods and/or services to the cardholder 102, including a cash currency value and an electrical energy amount equivalent to the cash currency value. For example, the merchant POS terminal 110 may transmit the cost to the cardholder by presenting the cost on a display of the POS terminal 110.

At operation 610, the cardholder 102 engages the consumer computing device 104 (or the electrical energy device 106) to initiate a transaction and determine an amount of available stored electrical energy that may be used in the transaction. For example, in an embodiment, the consumer computing device 104 may determine an amount of energy available for transfer from the power source of the consumer computing device 104. In another embodiment, the consumer computing device 104 may communicate (via a wired connection or wireless communication) with an external power source, such as the electrical energy device 106, and determine an amount of energy available for transfer from the external power source. In certain embodiments, the consumer computing device 104 (or the electrical energy device 106) may include data associated with a charging source for the available electrical energy. For example, the consumer computing device 104 (or the electrical energy device 106) may have been charged via a renewable energy source. The data associated with a charging source may be used to adjust the cash currency value of the electrical energy for the transaction. For example, a renewably charged power source (or battery) could be determined to have an increased currency value. The determination of the amount of available stored electrical energy that may be used in the transaction may include a breakdown of whether the stored electrical energy will completely cover the transaction cost or require a split payment transaction with partial electrical energy and cash currency.

At operation 612, the cardholder 102 selects, via the consumer computing device 104 (or the electrical energy device 106), a payment method for the transaction. For example, the cardholder 102 may select to pay the transaction amount in full with stored electrical energy only, pay in full via the debit/credit account associated with his or her electrical energy transfer payment service account, pay in full via cash or cash equivalent, or pay the amount via a split payment of stored electrical energy and his or her associated debit/credit account and/or cash.

At operation 614, the cardholder 102 taps the consumer computing device 104 (or the electrical energy device 106) at the merchant POS terminal 110. The tap initiates a tap-to-pay process using NFC technology to share payment data or information. NFC allows nearby devices to communicate through radio waves, so the devices do not have to make physical contact with the POS terminal 110 to complete the purchase. Via the tap, the POS terminal 110 communicates with the consumer computing device 104 (or the electrical energy device 106) and receives the payment data therefrom, for example, from the digital wallet of the consumer computing device 104 (or the electrical energy device 106), such as the digital wallet 226 (shown in FIG. 2). The payment data includes, without limitation, the unique PAN associated with the cardholder's electrical energy transfer payment service account (or corresponding token), the device ID, the amount of energy available for transfer, and the selected payment method for the transaction. In certain embodiments, the POS terminal 110 may request a personal identification number (or PIN) or other secondary authentication (e.g., a biometric) associated with the consumer computing device 104 and/or corresponding digital wallet.

In the exemplary embodiment, at operation 616, the POS terminal 110 transmits a payment authorization request message, for example, to the payment network 112. It is noted that the messages within a payment system, such the payment processing system 100 (shown in FIG. 1), in at least some instances, conform to the ISO Standard 8583 specification, which is the ISO standard for systems that exchange electronic transactions made by cardholders using payment devices. In the example embodiment, the payment authorization request message is an ISO 8583 message type identifier (MTI) “0100” message. The POS terminal 110 generates the payment authorization request message including, for example, data corresponding to a terminal ID, amount of the transaction, date of transaction, merchant location, the payment data received from the cardholder device, and other discretionary data. The payment authorization request message is transmitted to the payment network 112 for processing and further transmission to an issuing bank, such as the issuer 114 (shown in FIG. 1), for approval.

At operation 618, the payment network 112 receives the payment authorization request message and extracts the payment data and the amount of the transaction therefrom. At operation 620, the payment network 112 determines that the transaction is a direct electrical energy transfer transaction and validates the transaction details. For example, the payment network 112 accesses the electrical energy transfer payment service account associated with the PAN received in the payment data. The payment network 112 compares the device ID associated with the account to the device ID received in the payment data. If the device IDs do not match, the validation fails and the payment network 112 declines the transaction. If the device IDs match, the payment network 112 retrieves the payment data associated with the cardholder's account.

At operation 622, using the retrieved payment data, the payment network 112 transmits a payment authorization request message to the issuer associated with the payment data. For example, the payment network 112 may substitute the PAN associated with the cardholder's electrical energy transfer payment service account with an account identifier (e.g., a primary account number) associated with a payment account corresponding to the payment data associated with the cardholder's account.

At operation 624, the POS terminal 110 receives a payment authorization request response message from the issuer 114, for example, via the payment network 112, based on the cardholder's payment data associated with the cardholder's account. The payment authorization request response message includes an approval of the transaction if the cardholder's payment account balance is sufficient to cover the transaction amount. In the example embodiment, the payment authorization request response message is an ISO 8583 message type identifier (MTI) “0110” message.

At operation 626, in response to receiving the “0110” payment authorization request response message approving the transaction, the merchant 108 instructs the cardholder 102 to place the electrical energy device, such as the consumer computing device 104 and/or the electrical energy device 106, within a predetermined region proximate the wireless power/communication interface of the POS terminal 110 to establish an inductive link and effect wireless power transfer, as described herein. For example, the POS terminal 110 may present one or more instructions to the cardholder 102 via the cardholder computing device 104 and/or an output device of the POS terminal 110. The wireless power transfer may then be carried out over an inductive link in accordance with the well-known principles of inductive coupling or resonant inductive coupling.

At operation 628, after placement of the electrical energy device, the POS terminal 110 receives electrical energy from the cardholder's electrical energy device(s). As described herein, the merchant 108 has a merchant energy storage device 122. In an embodiment, the merchant energy storage device 122 may be an electrochemical energy storage device. As noted above, the electrochemical energy storage device may include one or more batteries, such as the battery 122 shown in FIG. 1. The battery 122 may be part of an emergency back-up power system or a stand-alone electrical energy storage device configured to perform direct electrical energy transfer transactions. When the cardholder 102 selects to fund a payment transaction with the merchant 108 using at least a portion of electrical energy, the merchant 108 may receive delivery of an amount of electrical energy to the battery 122.

At operation 630, the POS terminal determines the amount of electrical energy received from the cardholder's electrical energy device. If the POS terminal 110 receives an amount of electrical energy equal to the transaction amount, the POS terminal 110 terminates the wireless power transfer and completes the transaction using payment with the amount of electrical energy received from the cardholder's electrical energy device.

However, if the POS terminal 110 receives an amount of electrical energy less than the transaction amount, at operation 632, the POS terminal 110 determines a currency amount due. For example, the POS terminal 110 converts the amount of electrical energy received from the cardholder's electrical energy device to a cash value and subtracts that cash value from the transaction amount. The resulting difference is the currency amount due for the transaction.

At operation 634, the POS terminal 110 presents the currency amount due to the cardholder and an indication that the currency amount due will be charged to the cardholder's payment account on file with the cardholder's electrical energy transfer payment service account. At operation 636, the POS terminal 110 then initiates a cash value transaction for the currency amount due based on the received unique PAN. Furthermore, in some embodiments, if the POS terminal 110 receives an amount of electrical energy that is more than an amount to cover the transaction amount, the POS terminal 110 may transfer an amount of electrical energy equivalent to any overage back to the cardholder's electrical energy device(s) and/or transfer a cash value credit to the cardholder's payment account.

Advantageously, the systems and methods of the disclosure detailed above allow a conventional exchange of funds between merchants and customers, with the merchants and customers having selective ability to conduct transactions with electrical energy or a combination of electrical energy and money. As such, the consumer's payment device may be universally used and accepted by different merchants to conduct direct electrical energy transfer transactions, conventional money transactions, or hybrids of electrical energy transfer transactions and money transactions.

As detailed above, the technical problems addressed by the systems and methods of the disclosure include one or more of the following: (i) the inability to process payment transaction involving non-monetary payment; (ii) the inability of a consumer having an energy storage device to tender electrical energy in a transaction with a merchant; (iii) the inability of a merchant to accept electrical energy from a consumer in a payment transaction; (iv) the inability to coordinate electrical energy transfers between a consumer and a merchant for goods and/or services; and (v) the inability to process direct electrical energy transfer transactions and non-electrical energy transfer transactions between consumers and merchants with a single payment processing system.

The resulting technical benefits achieved by the systems and methods of the disclosure include one or more of the following: (i) improving a payment system by identifying and distinguishing payment transactions involving non-monetary forms of payment between a consumer and a merchant from payment transactions involving monetary payments; (ii) accepting a consumer's electrical energy payment in a payment transaction with a merchant; (iii) administrating an electrical energy transfer from a consumer's electrical energy device to a merchant's electrical energy storage device in a payment transaction; (iv) initiating and coordinating electrical energy transfer between a consumer's electrical energy device to a merchant's electrical energy storage device in a payment transaction; and (v) processing both direct electrical energy transfer transactions and non-electrical energy transfer transactions between consumers and merchants with the same payment processing system.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the phrases “payment card,” “payment device,” “transaction card,” “financial transaction card,” and the like refer to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system comprising:
a wireless power/communication interface;
an energy storage device;
one or more processors; and
a memory device storing computer-executable instructions thereon that, when executed by the one or more processors, cause the one or more processors to:
receive a transaction request from a cardholder device associated with a cardholder;
determine that the transaction request corresponds to a direct electrical energy transfer transaction, the direct electrical energy transfer transaction involving a purchase of goods or services by the cardholder in exchange for an amount of electrical energy transferrable to a merchant via the cardholder device;
transmit a transaction cost of the purchase of goods or services to the cardholder device, the transaction cost including a cash currency value and an electrical energy amount equivalent to the cash currency value;
receive payment data from the cardholder device;
transmit a payment authorization request message for the direct electrical energy transfer transaction to a payment network for approval, the payment authorization request message including the payment data;
receive a payment authorization request response message from the payment network, the payment authorization request message including an approval of the direct electrical energy transfer transaction;
after receiving approval of the direct electrical energy transfer transaction, receive, via the wireless power/communication interface, an amount of electrical energy from the cardholder device;
determine the amount of electrical energy received from the cardholder device;
store the amount of electrical energy in the energy storage device; and
conduct the transaction using payment with electrical energy based on the amount of electrical energy received.

2. The system in accordance with claim 1,
said computer-executable instructions further causing the one or more processors to establish, via the wireless power/communication interface, an inductive link with the cardholder device.

3. The system in accordance with claim 2,
said computer-executable instructions further causing the one or more processors to present one or more instructions to the cardholder instructing the cardholder to place the cardholder device proximate the wireless power/communication interface.

4. The system in accordance with claim 1,
said step of determining the amount of electrical energy received from the cardholder device comprises determining that the amount of electrical energy received is less than the electrical energy amount equivalent to the cash currency value,
based on the determination, said computer-executable instructions further causing the one or more processors to initiate a cash value transaction for a currency amount due.

5. The system in accordance with claim 4,
said computer-executable instructions further causing the one or more processors to determine the currency amount due, comprising:
converting the amount of electrical energy received to a cash value; and
subtract the cash value from the cash currency value, wherein a resulting difference is the currency amount due.

6. The system in accordance with claim 1,
said computer-executable instructions further causing the one or more processors to:
transmit an energy value request message to the payment network; and
receive energy value data from the payment network.

7. The system in accordance with claim 6, wherein the energy value data includes currency conversion data that allows a quantity of electrical energy to be converted to a cash value.

8. The system in accordance with claim 1,
said operation of receiving the transaction request from the cardholder device comprising receiving a cardholder-selected payment method, the payment method comprising one of the following:
pay the transaction cost with electrical energy only; and
pay the transaction cost using a combination of electrical energy and one or more of cash and a payment account associated with the cardholder.

9. The system in accordance with claim 1,
said energy storage device comprising an electrochemical energy storage device.

10. The system in accordance with claim 9,
said electrochemical energy storage device comprising one or more batteries.

11. A method implemented in a payment processing system including a point-of-sale (POS) terminal having one or more processors in communication with a wireless power/communication interface, an energy storage device, a memory device, and a payment network, said method comprising:
receiving a transaction request from a cardholder device associated with a cardholder;
determining that the transaction request corresponds to a direct electrical energy transfer transaction, the direct electrical energy transfer transaction involving a purchase of goods or services by the cardholder in exchange for an amount of electrical energy transferrable to a merchant via the cardholder device;
transmitting a transaction cost of the purchase of goods or services to the cardholder device, the transaction cost including a cash currency value and an electrical energy amount equivalent to the cash currency value;
receiving payment data from the cardholder device;
transmitting a payment authorization request message for the direct electrical energy transfer transaction to the payment network for approval, the payment authorization request message including the payment data;
receiving a payment authorization request response message from the payment network, the payment authorization request message including an approval of the direct electrical energy transfer transaction;
after receiving approval of the direct electrical energy transfer transaction, receiving, via the wireless power/communication interface, an amount of electrical energy from the cardholder device;
determining the amount of electrical energy received from the cardholder device;
storing the amount of electrical energy in the energy storage device; and
conducting the transaction using payment with electrical energy based on the amount of electrical energy received.

12. The method in accordance with claim 11, further comprising establishing, via the wireless power/communication interface, an inductive link with the cardholder device.

13. The method in accordance with claim 12, further comprising presenting one or more instructions to the cardholder instructing the cardholder to place the cardholder device proximate the wireless power/communication interface.

14. The method in accordance with claim 11,
said step of determining the amount of electrical energy received from the cardholder device comprises determining that the amount of electrical energy received is less than the electrical energy amount equivalent to the cash currency value,
based on the determination, said method further comprising initiating a cash value transaction for a currency amount due.

15. The method in accordance with claim 14, further comprising determining the currency amount due, comprising:
converting the amount of electrical energy received to a cash value; and
subtract the cash value from the cash currency value, wherein a resulting difference is the currency amount due.

16. The method in accordance with claim 11, further comprising:
transmitting an energy value request message to the payment network; and
receiving energy value data from the payment network.

17. The method in accordance with claim 16, wherein the energy value data includes currency conversion data that allows a quantity of electrical energy to be converted to a cash value.

18. The method in accordance with claim 11,
said operation of receiving the transaction request from the cardholder device comprises receiving a cardholder-selected payment method, the payment method comprising one of the following:
pay the transaction cost with electrical energy only; and
pay the transaction cost using a combination of electrical energy and one or more of cash and a payment account associated with the cardholder.

19. A non-transitory computer readable medium including computer-executable instructions that when executed by a computing device having one or more processors in communication with a wireless power/communication interface, an energy storage device, a memory device, and a payment network, cause the computing device to:
receive a transaction request from a cardholder device associated with a cardholder;
determine that the transaction request corresponds to a direct electrical energy transfer transaction, the direct electrical energy transfer transaction involving a purchase of goods or services by the cardholder in exchange for an amount of electrical energy transferrable to a merchant via the cardholder device;
transmit a transaction cost of the purchase of goods or services to the cardholder device, the transaction cost including a cash currency value and an electrical energy amount equivalent to the cash currency value;
receive payment data from the cardholder device;
transmit a payment authorization request message for the direct electrical energy transfer transaction to the payment network for approval, the payment authorization request message including the payment data;
receive a payment authorization request response message from the payment network, the payment authorization request message including an approval of the direct electrical energy transfer transaction;
after receiving approval of the direct electrical energy transfer transaction, receive, via the wireless power/communication interface, an amount of electrical energy from the cardholder device;
determine the amount of electrical energy received from the cardholder device;
store the amount of electrical energy in the energy storage device; and
conduct the transaction using payment with electrical energy based on the amount of electrical energy received.

20. The non-transitory computer readable medium in accordance with claim 19,
said step of determining the amount of electrical energy received from the cardholder device comprises determining that the amount of electrical energy received is less than the electrical energy amount equivalent to the cash currency value,
the computer-executable instructions further causing the computing device to:
transmit an energy value request message to the payment network;
receive energy value data from the payment network, the energy value data including currency conversion data that allows a quantity of electrical energy to be converted to a cash value;
based on the determination, initiate a cash value transaction for a currency amount due; and
determine the currency amount due, comprising:
converting the amount of electrical energy received to a cash value using the currency conversion data; and
subtracting the cash value from the cash currency value, wherein a resulting difference is the currency amount due.
